(19) United States
(12) Patent Application Publication
(10) Pub. No.: US 2008/0234395 A1
(43) Pub. Date: Sep. 25, 2008

(54) Viscouse dispersion of semiconductor nanoparticles

(76) Inventor: Tsutomu Miyasaka, Tokyo (JP)

Correspondence Address: NIXON PEABODY, LLP, 401 9TH STREET, NW, SUITE 900, WASHINGTON, DC, 20004-2128, US

(21) Appl. No.: 11/723,963

(22) Filed: Mar. 22, 2007

(51) Int. Cl. B01F 3/14

(52) U.S. Cl. 516/33; 516/31

(57) ABSTRACT

The present invention provides a viscous dispersion comprising crystalline semiconductor nanoparticles, which is useful for formation of a porous semiconductor membrane of high purity at a low temperature. The viscous dispersion comprises crystalline semiconductor nanoparticles dispersed in a dispersion medium, wherein the dispersion medium is a mixture comprising 53 to 92 wt % of a hydrophilic organic medium and 8 to 47 wt % of water, said hydrophilic organic medium comprising an alcohol having 3 to 5 carbon atoms as a main component, wherein the dispersion medium essentially does not contain an organic binder, an amount of said organic binder being less than 2 wt % of the medium, and wherein the dispersion comprises 8 to 40 wt % of the dispersed crystalline semiconductor nanoparticles based on the total amount of the dispersion.

### FIELD OF THE INVENTION

The present invention relates to highly viscous paste comprising semiconductor nanoparticles and a dispersing medium, which essentially does not contain any insulating organic binders such as a resin.

### BACKGROUND OF THE INVENTION

The semiconductor nanoparticles, which are represented by titanium dioxide particles, have been widely used for formation of an ultra thin membrane or a porous membrane in a photocatalyst field, a condenser, a capacitor and a battery in electronics fields, or a fuel cell and a solar cell in energy fields. The photocatalyst, particularly a material containing nanoparticles of titanium dioxide has been used in the form of paste or spraying material to form such membranes as a coating material and a surface modification material in industry. In the energy field, a storage unit or a dye-sensitized solar cell has actively been developed by using the semiconductor nanoparticles, which have large specific surface area, as electrode materials. The dye-sensitized solar cell is a low-cost solar battery, which can replace a conventional solar battery of a solid junction type using a p-n junction of silicon or a hetero junction of compound semiconductor. The dye-sensitized solar battery is one of the most important technologies using a porous membrane of semiconductor nanoparticles.

The basic technology of the dye-sensitized solar battery is described in Nature, vol. 353, p. 737-740, 1991 and U.S. Pat. No. 4,927,721 (claims and others). The dye-sensitized solar battery has sensitivity to visible light up to the wavelength of 800 nm. Its energy efficiency has already reached 10% or more. The dye-sensitized solar battery has been intensively investigated toward achievement of the energy efficiency of 15% or more, which goes beyond that of the amorphous silicone solar battery.

The dye-sensitized solar battery can have a characteristic distinct from that of the silicon solar battery. For example, the dye-sensitized solar battery can be colorful and transparent. The colorful and transparent battery, particularly a dye-sensitized solar battery in the form of a film having a plastic material substrate has actively been developed. In preparation of a conventional dye-sensitized solar battery of a glass plate type, a coated viscous dispersion of semiconductor nanoparticles containing a binder for increasing viscosity is sintered at a high temperature (of not lower than 450° C.) to burn out the binder and to form a porous semiconductor membrane on the other hand, the membrane should be formed at a low temperature in preparation of the dye-sensitized solar battery of a film type having a plastic material substrate. The porous semiconductor membrane can be formed at a low temperature for preparation of the solar battery of the film type by using a method of electrophoresis, as is described in Chemistry Letters, 2002, p. 1,250 and Japanese Patent Provisional Publication No. 2002-100416 (e.g., claims and others). Further, a pressing method comprising the steps of: coating an electrode substrate with a dispersion of semiconductor particles; and pressing coated dispersion (claims and others).

According to the above-described methods, a porous semiconductor membrane can be formed at a low temperature of not higher than 150° C., which is lower than the temperature of the heat resistance of the plastic material electrode. Therefore, the methods have an advantage in that a roll-to-roll coating process of a printing field can be used to produce a solar battery at a low cost. The energy efficiency of the solar battery having the above-prepared electrode, however, has a disadvantage in that an energy efficiency is approximately 1 to 3%, which is lower than that of the glass electrode prepared according to the conventional sintering method.

In the conventional method, impurities originating from starting materials have completely been removed by burning them at a high temperature. On the other hand, impurities cannot completely be removed by a low temperature method of forming a membrane at a low temperature, such as the pressing method. Impurities (usually organic substances) in a dispersing medium of the semiconductor particles or a small amount of a binder for formation of the membrane are insulating materials, which emigrate into the porous semiconductor membrane to lower the efficiency. Therefore, it is strongly desired to reduce the amount of polymer resin used as the binder material and organic impurities to a certain level in the low temperature method to form a dye-sensitized semiconductor membrane of high purity essentially free from the binder, which can prepare a light and large solar battery of a film type.

### SUMMARY OF THE INVENTION

The present inventor has studied to a viscous dispersion containing semiconductor nanoparticles, which can be used to form a porous semiconductor membrane of high purity at a low temperature. The present invention has been completed based on study of the inventor.

In more detail, the present inventor has studied the composition of the viscous liquid composition to form a porous semiconductor membrane on a plastic material film at a low temperature, and found the optimum composition. As a result, a solvent (dispersing medium) for dispersing semiconductor nanoparticles has been selected, and a mixing ratio of the solvent to the sol containing the semiconductor has been adjusted to invent a viscous dispersion containing semiconductor nanoparticles, which can form a porous thin membrane having a firm adhesion to a film.

The present invention resides in a viscous dispersion comprising crystalline semiconductor nanoparticles dispersed in a dispersing medium, wherein the dispersing medium is a mixture comprising 53 to 92 wt % of a hydrophilic organic medium and 8 to 47 wt % of water, said hydrophilic organic medium comprising an alcohol having 3 to 5 carbon atoms as a main component, wherein the dispersing medium essentially does not contain an organic binder, an amount of said organic binder being less than 2 wt % of the medium, and wherein the dispersion comprises 8 to 40 wt % of the dispersed crystalline semiconductor nanoparticles based on the total amount of the dispersion.

### EFFECT OF THE INVENTION

The viscous dispersion containing semiconductor nanoparticles according to the present invention can be used to form a porous semiconductor membrane on a universally applicable film or a conductive film by coating the film with it at a low temperature. Therefore, a dye-sensitized photo cell of a film type excellent in energy efficiency and storage durability can be manufactured by using the viscous dispersion containing semiconductor nanoparticles according to the present invention.

### DETAILED DESCRIPTION OF THE INVENTION

The viscous dispersion containing semiconductor nanoparticles according to the present invention (which is hereinafter also referred to as the paste) can be employed for forming a porous semiconductor thin membrane by coating a material for a porous semiconductor layer such as titanium dioxide on a substrate at a low temperature. It is particularly useful for forming a plastic film electrode, which should be formed at a low temperature. The paste of the invention is a viscous white opaque liquid in which crystalline semiconductor nanoparticles are dispersed as main components. The paste does not essentially contain a binder or contains a limited small amount of a binder material such as a resin or latex, which is usually used to increase viscosity or to improve adhesion of a formed membrane to a substrate. Therefore, the formed porous semiconductor thin membrane still has conductivity of a high level.

The crystalline nanoparticles contained in the paste of the invention can be prepared according to the known method. The methods for preparation include a sol-gel processing method, described in “Science of sol-gel processing (written in Japanese)”, Agne Shofu-sha, 1998, a method of forming an oxide by hydrolysis of a metal chloride in an acidic hydrogen salt at an elevated temperature, or a spray thermal decomposition method of forming ultra fine particles by gas-phase thermal decomposition of a metal compound at an elevated temperature. The ultra fine particles or nanoparticles of titanium dioxide prepared by the above-mentioned methods are described in “Compendium of Fine Particle Engineering (written in Japanese)”, Vol. II, Applied Technology, supervised by Hiroaki Yanagida, Fujitech Corporation (2002).

The paste of the invention contains nanoparticles of a crystalline semiconductor material as the main component. A metal oxide or a metal chalcogenide can be used as the semiconductor material. The metal atoms of the oxide and chalcogenide include titanium, tin, zinc, iron, tungsten, zirconium, strontium, indium, cerium, vanadium, niobium, tantalum, cadmium, lead, antimony, and bismuth. A metal compound having a perovskite-type structure can also be used. Examples of the metal compounds include strontium titanate, calcium titanate, sodium titanate, barium titanate, and potassium niobate.

A preferred semiconductor material is an inorganic semiconductor of n-type, such as TiO₂, TiSrO₃, ZnO, Nb₂O₃, SnO₂, WO3, Si, CdS, CdSe, V₂O₅, ZnS, ZnSe, SnSe, KTaO₃, FeS₂, and PbS. A more preferred semiconductor is a semiconductor material comprising a metal oxide, such as TiO₂, ZnO, SnO₂, WO3, and Nb₂O₃. Particularly preferred is titanium dioxide (TiO₂).

In the case that nanoparticles of crystalline titanium dioxide are used in the paste of the invention, the nanoparticles of titanium dioxide have a crystalline structure of a rutile type, an anatase type or a brookite type. Preferred particles in the paste of the invention are anatase crystals and brookite crystals. The paste of the invention preferably comprises a mixture of at least anatase crystal particles and brookite crystal particles. The crystalline structure can be determined by measurement of diffraction pattern according to the X-ray diffraction studies or detection of the crystal lattice according to observation by transmission electron microscope. The crystalline structure is preferably determined by the X-ray diffraction studies. The particles of titanium dioxide can have amorphous, spherical, polyhedral, fibrous or nanotubular shapes. The polyhedral or nanotublar shapes are preferred, and the polyhedral shape is particularly preferred.

The semiconductor nanoparticles (e.g., nanoparticles of titanium dioxide) contained in the paste have an average particle size preferably of not less than 10 nm and less than 150 nm. The average particle size more preferably is not less than 15 nm, and not more than 100 nm. The average particle size most preferably is not less than 20 nm, and not more than 80 nm. The average particle size of the nanoparticles can be calculated from, for example, light correlation using a laser light scattering method or particle size distribution measured by observation with the aid of a scanning electron microscopy.

The semiconductor nanoparticles (e.g., titanium dioxide nanoparticles) contained in the paste can comprise two or more kinds of particles which are different from each other in average particle size and particle size distribution. Specifically, fine particles having a large average particle size can be mixed with the nanoparticles. In this case, the contained large particles preferably are crystalline titanium dioxide particles having an average particle size of not less than 150 nm and not more than 600 nm. The large particles can be added to the nanoparticles in a weight ratio of 5 to 80% based on the amount of the nanoparticles. The weight ratio preferably is in the range of 10 to 50%.

The semiconductor nanoparticles are preferably used in an amount of not less than 8 wt % and not more than 40 wt %, and more preferably used in an amount of not less than 15 wt % and not more than 35 wt %.

In the paste of the invention, the semiconductor can be mixed with other various inorganic compounds as additives. The inorganic compounds include various oxides, semiconductor materials and conductive materials. The inorganic oxides include metals (e.g., alkali metal, alkaline earth metal, transition metal, rare earth metal, lanthanoid) and oxides thereof and nonmetal (e.g., Si, P, Se) oxides. Examples of the metals include Al, Ge, Sn, In, Sb, Tl, Pb, and Bi. Examples of alkali and alkaline earth metals include Li, Mg, Ca, Sr, and Ba. Examples of the transition metals include Ti, V, Cr, Mn, Fe, Ni, Zn, Nb, Mo, Ru, Pd, W, Os, Ir, Pt, and Au. Examples of the conductive materials include metals (including noble metals) and carbonaceous materials.

The paste of the invention is a viscous liquid composition having a sufficiently high viscosity required for coating. The viscosity is preferably not less than 800 mPa·s. Herein, 1 mPa·s corresponds to 1 centipoise. The viscosity of the paste can be measured according to a method of measuring a capillary viscosity or a rotating viscosity. The paste of the invention more preferably has a viscosity of not less than 1,000 mPa·s. The viscosity of the paste further preferably is not less than 3,000 mPa·s and not more than 15,000 mPa·s.

The dispersing medium used in the viscous liquid composition of the invention is a mixture comprising a hydrophilic organic medium and water. The hydrophilic organic medium comprises an alcohol having 3 to 5 carbon atoms as a main component. Examples of the alcohols include aliphatic alcohols such as propanol, butanol and pentanol. The alcohols can have a straight or branched chain. Examples include 1-propanol, 2-propanol, 1-butanol, tert-butanol, 1-pentanol, and 2-pentanol. Preferred are branched aliphatic alcohols, such as 2-propanol and tert-butanol. The most preferred is tert-butanol. The hydrophilic organic medium can contain a small amount (not more than 30 wt %, preferably not more than 20 wt %, more preferably not more than 10 wt %, and most preferably not more than 5 wt %) of other lower alcohols, such as methanol and ethanol or other hydrophilic organic mediums, such as acetone and an ether.

In the paste of the invention, water is mixed with the alcohol as the dispersing medium. Water is added to the paste to disperse the nanoparticles well and to keep the appropriate viscosity of the paste. The content of water in the mixed medium is not less than 8 wt % and not more than 43 wt %. The content of water more preferably is not less than 15 wt % and not more than 35 wt %, and further preferably is not less than 15 wt % and not more than 25 wt %. The volume ratio of water to the alcohol in the paste of the invention preferably is in the range of 1:7 to 1:1.7. Addition of water is particularly effective in a paste using oxide semiconductor nanoparticles, such as titanium dioxide nanoparticles.

In the case that a binder comprising an organic material is used with the paste of the invention, the content of the binder is preferably smaller than a certain level. The binder means a binding aid having effects of adhering particles with each other or attaching the particles to the substrate. Examples of the binders include a resin material, a polymer material or wax. In the paste of the invention, the amount of the binder comprising an organic material should be less than 2% of the total weight amount of the paste. It is preferred that the paste of the invention essentially does not contain a binder. The tern “essentially does not contain a binder” means that the amount of the binder comprising an organic material is not more than 1 wt % based on the total amount of the composition. The amount of the binder is more preferably adjusted to not more than 0.5 wt %. Examples of the binder resins include polyethylene glycol, methylcellulose, ethylcellulose, polyvinylidene fluoride, polymethyl methacrylate, and polyacrylonitrile.

The paste of the invention preferably is an acidic liquid to keep the oxide semiconductor nanoparticles from agglutination. The pH of the acidic liquid preferably is in the range of 1 to 6, and more preferably is in the range of 3 to 5.

An electrode covered with a porous metal oxide semiconductor layer can be prepared by coating an electrode substrate with the paste of the invention and heating it at a low temperature. The porous metal oxide semiconductor layer can be well fixed to the substrate by coating the substrate with the paste of the invention in thickness of 50 to 200 μm, drying the obtained liquid membrane, and heating it at a low temperature of not lower than room temperature and not higher than 150° C. The low heating temperature preferably is in the range of 120 to 150° C. The prepared porous layer is a mesoporous membrane having pores of nano size. The paste of the invention can be coated by a doctor blade method, a squeegee method, or a screen printing method.

The substrate to be coated with the paste can be a substrate made of glass, metal or plastic, or an electrode substrate. Preferred is a substrate or electrode that comprises a flexible plastic material support. More preferably is a transparent conductive plastic material film, which can be used as an electrode. Most preferably used is a transparent conductive plastic material film having a surface resistance of not higher than 20Ω per square. The electrode prepared by using the paste of the invention preferably is a transparent conductive plastic material film having a surface resistance of not higher than 20Ω per square having a surface covered with a porous-semiconductor layer. The thickness of the plastic electrode including the porous semiconductor layer preferably is in the range of 150 to 700 μm, and is more preferably in the range of 200 to 450 nm. The thickness of the plastic support itself preferably is in the range of 140 to 650 μm, and more preferably is in the range of 180 to 400 μm.

The transparent conductive plastic material film to be coated with the paste of the invention comprises a conductive layer and a plastic material substrate on which the conductive layer is formed. The plastic material substrate of the transparent conductive plastic film preferably is colorless and highly transparent, and preferably has a heat-resistance, a chemical resistance and a gas shielding function. The substrate preferably is not expensive. The plastic materials for the substrate include polyethylene terephthalate (PET), polyethylene naphthalate (PEN), syndiotactic polystyrene (SPS), polyphenylene sulfide (PPS), polycarbonate (PC), polyarylate (PAr), polysulfone (PSF), polyester sulfone (PES), polyether imide (PEI), and transparent polyimide (PI). The plastic material preferably is polyethylene terephthalate (PET) or polyethylene naphthalate (PEN) in view of the chemical resistance and the low cost.

The conductive layer of the transparent conductive plastic material substrate can comprise a conductive material such as metal (e.g., platinum, gold, silver, copper, aluminum, and indium), carbon, or conductive metal oxide (e.g., indium zinc complex oxide, and tin oxide). The conductive metal oxide is preferred in view of the optical transparency. The indium tin complex oxide (ITO) and tin oxide are particularly preferred. The surface conductive layer should have a low surface resistance (or a sheet resistance). The surface resistance preferably is not higher than 20Ω per square, more preferably is not higher than 10Ω per square, and most preferably is not higher than 3Ω per square. The conductive layer can be patterned with an auxiliary lead for serving as collector. The auxiliary lead is usually formed with a metal material of a low resistance, such as copper, silver, aluminum, platinum, gold, titanium, and nickel. In the case that the transparent conductive layer is patterned with the auxiliary lead, the surface resistance is measured as the value of the whole surface including the auxiliary lead. The surface resistance of the whole surface preferably is not higher 10Ω per square, and more preferably is not higher than 3Ω per square. In the case that the transparent plastic material substrate is patterned with the auxiliary lead, and the transparent conductive layer such as ITO membrane is preferably formed on them.

The plastic electrode having the porous semiconductor membrane obtained by using the paste of the invention can be used as a dye-sensitized electrode. In preparation of the dye-sensitized electrode, the surface of the metal oxide semiconductor layer should be sensitized by absorption of a dye. Various known sensitizing materials have been used in a dye-sensitized semiconductor. The known materials can also be used as the sensitizing dye molecules in the invention. Examples include organic dyes, such as cyanine dyes, merocyanine dyes, oxonol dyes, xanthene dyes, squalirium dyes, polymethine dyes, coumarin dyes, riboflavin dyes and perylene dyes, and complex dyes, such as ruthenium complexes, metal phthalocyanine derivatives, metal porphyrin derivatives, and chlorophyll derivatives. The other natural or synthetic sensitizing dyes are described in Functional Material (written in Japanese), 2003, June, p. 5-18. Further, an organic dye such as coumarin disclosed in J. Chem. Phys., 2003, vol. B107, p. 597 can also be used as the sensitizing dye.

The porous semiconductor layer formed on the plastic electrode substrate essentially consists of inorganic materials including a semiconductor and a dye. The term “essentially consists of inorganic materials including a semiconductor and a dye” means that the inorganic materials including a semiconductor and the dye are the main components of the particle layer, and the total amount of the main components are essentially the same as the total solid content of the particle layer. Solid components other than the inorganic materials including a semiconductor and the dye may be contained in the particle layer. Examples of the other solid components include a small amount of a polymer resin binder and a carbonaceous material. The solid components other than the inorganic materials including a semiconductor and the dye preferably contains in an amount of not more than 1 wt % based on the total weight of the porous semiconductor layer.

The amount of the inorganic compounds including the semiconductor based on the total weight of the porous particle layer can be determined in the present invention. For example, the amount can be measured by peeling the porous particle layer from the plastic material support, washing with a solvent of an electrolytic solution to remove liquid or solid components derived from components of the electrolytic solution or others, which are different from the components of the particle layer contained in the porous particle layer, drying the obtained particle layer itself, and measuring the weight of the particle layer. The measured weight means the weight of the total solid content.

The total solid components are then washed with a polar organic solvent, such as an alcohol or acetonitrile and a non-polar solvent, such as toluene or chloroform to remove organic materials, and heating the particle layer at a temperature of not lower than 400° C. for one hour or more in an atmosphere of oxygen or air, and measuring the weight of the residue. The dry weight of the residue is divided with the weight of the total solid content. The obtained ratio means the ratio of the weight of the inorganic compounds including the semiconductor to the weight of the total solid contents.

The weight ratio of the dye in the dye-sensitized electrode can be determined according to the following manner. For example, the weight ratio can be determined by peeling the particle layer from the plastic support, measuring the total amount, washing well with water or an organic solvent capable of eluting the dye, such as methanol or acetonitrile to remove the dye from the particle layer. The particle layer is so washed that the color of the dye scarcely remains in the particle layer. After evaporating the solvent from the washed solution containing the dye, the dry weight of the remaining dye is measured. The dry weight of the dye is divided with the weight of the total solid content. The obtained value is the desired ratio of the dye.

Subtraction of the sum of the ratio of the inorganic compounds and the ratio of the dye from 1 gives the ratio of the solid components other than the inorganic compounds and the dye to the total weight of the particle layer. The solid components other than the inorganic compound and the dye include a binder, such as a polymer resin.

In the porous semiconductor layer formed by coating the paste of the invention, the void volume represented by the volume ratio preferably is in the range of 40% to 85%, and more preferably is in the range of 50% to 75%.

A porous metal oxide semiconductor electrode is formed by coating a plastic electrode with the paste of the invention. A dye-sensitized solar battery and a photo cell can be prepared by using the formed porous metal oxide semiconductor electrode. A porous metal oxide semiconductor layer having an excellent function is a titanium dioxide layer. A solar battery or a photoelectric conversion element of a mechanically flexible film type can have a multi-layered structure comprising a photovoltaic electrode, which is a dye-sensitized electrode having a porous titanium dioxide layer absorbing a dye, an ion conductive layer, and a counter electrode.

An ion conductive electrolyte layer of the solar battery film can comprise an aqueous electrolytic solution, an organic solvent electrolytic solution or an ionic liquid electrolytic solution (melt salt electrolytic liquid). Examples of the redox compounds contained in the electrolytic solution include a combination of 12 and an iodide such as a metal iodide (e.g., LiI, NaI, KI) and a quarternary ammonium iodide (e.g., a tetraalkylammonium iodide, pyridinium iodide, imidazolium iodide): a combination of Br₂ and a bromide such as a metal bromide (e.g., LiBr, NaBr, KBr) and a quarternary ammonium bromide (e.g., a tetraalkylammonium bromide, pyridinium bromide); a metal complex, such as a ferrocyanateferricyanate salt and a ferrocene-ferricynium ion; and a sulfur compound such as polysodium sulfide and alkylthiol-alkyldisulfide. The combination of I₂ and LiI or a quarternary ammonium iodide, such as pyridinium iodide or imidazolium iodide is particularly preferred for giving high performance of the solar battery.

The conductive layer of the counter electrode in the solar battery comprises a conductive material. Examples of the conductive materials include a metal, such as platinum, gold, silver, copper, titanium, aluminum, manganese, and indium; a carbonaceous material; and a conductive metal oxide, such as indium-tin complex oxide (ITO) and fluorine-doped tin oxide (FTO). Platinum, titanium, an ITO membrane and a carbonaceous material are preferred from the viewpoint of corrosion resistance.

The solar battery of a film type prepared by using the paste of the invention can have various optional layers in addition to the above-mentioned basic layered structure. For example, a thin dense semiconductor membrane can be provided as an undercoating layer between the conductive plastic material substrate and a porous conductive layer.

The undercoating layer preferably comprises a metal oxide, such as TiO₂, SnO₂, Fe₂O₃, WO₃, ZnO, and Nb₂O₃. The undercoating layer can be formed according to a spray pyrolysis method described in Electrochim. Acta 40, 643-652 (1995) or a sputtering method. The preferred thickness of the undercoating layer is 5 to 100 nm. Functional layers, such as a protective layer, an anti-reflection layer or a gas-barrier layer can be provided on one or both outer surfaces of a porous semiconductor electrode, which functions as a photovoltaic electrode, or a counter electrode, between the conductive layer and the substrate or as intermediate of the substrate. The functional layers can be formed by a coating method, an evaporating method, or a pasting method, which is selected according to the material of the layer.

The best mode for conducting the invention is described in the following example.

### EXAMPLE

### [Preparation of Viscous Liquid Composition]

60 mL of acidic aqueous sol solution (concentration: 20 wt %) was mixed with 150 mL of tert-butanol. In the sol solution, 21 g of particle powder comprising crystalline titanium dioxide nanoparticles of a rutile/anatase mixed type (average particle size: 60 nm) and crystalline titanium dioxide particles of a rutile type (average particle size: about 300 nm, particle size distribution: 200 to 500 nm) in the mixed weight ratio of 5:1 and titanium nanoparticles comprising crystals of a brookite type (particle size: 10 to 30 nm) had been dispersed. The mixture was uniformly stirred and mixed in a mixing conditioner revolving on both inside and outside axes to prepare a white viscous liquid composition (mass: about 220 g), The water content in the paste was 25 vol % or 27 wt % based on the total composition. The weight ratio of water to the alcohol was 1:2.7. The content of titanium dioxide in the paste was 16 wt %. The paste consisted of only titanium dioxide and the solvent, and was a viscous binder-free paste, which did not contain a binder. The viscosity of the paste measured by a rotation viscometer was 2,400 mP·s. The paste was an acidic liquid, and pH was 4.

In comparison experiments, various pastes having compositions different from that of the above-mentioned paste were prepared. First, pastes having different water contents were prepared by changing the amounts of the sol solution and the alcohol. Second, pastes were prepared using 2-propanol (isopropyl alcohol), 1-pentanol or 1-hexanol in place of tert-butanol as the alcohol for dispersion. Third, pastes having titanium oxide contents in the range of 5 wt % to 50 wt % have been prepared by changing the amount of the titanium dioxide particle powder in the paste. Fourth, a paste was prepared using an aqueous dispersion (sol solution) of crystalline particles (average particle size: 15 nm) of a mixture of rutile and anatase types, which did not contain crystalline particles of the brookite type, in place of the above-mentioned sol solution in which titanium dioxide nanoparticles containing crystalline particles of the brookite type were dispersed.

### [Evaluation of Characteristics of Paste]

The above-mentioned pastes having different compositions were evaluated in view of the viscosity, the coating capability and the storage stability. The coating capability was evaluated as follows. A polyethylene terephthalate film (thickness: 125 μm) was coated with the paste according to a squeegee method to form a liquid membrane having a thickness of 100 μm. The coated membrane was dried at room temperature, and further dried at 150° C. for 5 minutes. The quality of the obtained dry membrane was evaluated from two viewpoints. The first viewpoint was the uniformity on the surface of the membrane, which was evaluated from visual observation. The second viewpoint was the strength of the adhesion of the semiconductor membrane, which was evaluated by testing the film with respect to fatigue. In the test, the film was mechanically curled as much as 10 times to reach the radius of curvature of 1.0 cm⁻¹. After the test, the state of the peeled porous semiconductor layer was evaluated with visual observation. The results were classified into three grades, that is, A (Excellent), B (Good) and C (Inferior to B, but practically usable).

In evaluation of the storage stability, the paste was placed in a sealed vessel, and kept for 30 days at 4° C. in a refrigerator. After storage, the vessel was manually shaken to stir the paste. The viscosity was measured again. The storage stability was classified by the changes of the viscosity and the coating capability into three grades, that is, A (Excellent), B (Good) and C (Inferior to B, but practically usable). The compositions of the prepared pastes in the tests are set forth in Table 1, and the results of the viscosity, coating capability and the storage stability of the pasts are set forth in Table 2.

### [Preparation of Pastes of Various Semiconductor Nanoparticles]

A binder-free paste was prepared in the same manner as in the above-described Example, except that tin oxide (average particle size: 35 nm), zinc oxide (average particle size: 60 nm) or cadmium sulfite (particle size: 10 to 50 nm) was used as the semiconductor nanoparticles in place of the above-mentioned titanium dioxide. With the semiconductors, an aqueous gel solution of titanium dioxide nanoparticles containing crystalline particles of a brookite type are mixed in the same manner as in the above-mentioned Example. Tert-butanol was used as the alcohol. The water content in the obtained paste was 23 to 30 wt % based on the total composition. The content of the semiconductor was 15 to 22 wt %. The obtained three kinds of pastes were evaluated with respect to the viscosity, the coating capability and the storage stability. The compositions of the pastes are set forth in Table 1, and the results of the evaluations are set forth in Table 2.

### [Preparation of Dye-Sensitized Solar Battery Using Paste]

### (1) Preparation of Plastic Film Electrode

A polyethylene terephthalate (PET) film having ITO as a conductive membrane (thickness: 200 μm, surface resistance: 15Ω per square) was used as a transparent conductive plastic material film. The ITO membrane was patterned with a silver auxiliary lead (line width: 100 μm, thickness: 20 μm) for collector in parallel with distance of 10 mm according to a screen printing method. The silver pattern was coated with a polyester resin (width 250 μm) as a protective membrane to protect the silver lines completely. The obtained conductive ITO-PET film having the pattern had the practical sheet resistance of 3Ω per square.

The ITO surface of the ITO-PET film was coated with the titanium dioxide-tert-butyl dispersion paste (water content: 27 wt %) prepared in the above-mentioned Example (liquid thickness: 100 μm) according to a doctor blade method, dried at room temperature, and further dried at 150° C. for 5 minutes to form a film electrode having a porous titanium oxide particle layer.

In preparation of a comparative electrode, polyethylene glycol (PEG) powder having the average molecular weight of 50,000 was added as a resin binder, which was a solid content other than the semiconductor material, to the composition of the paste for preparation of an electrode to prepare a paste containing the binder. The content of the PEG was changed from 0.2 wt % to 5 wt % for comparison. For comparison of different semiconductor nanoparticles, a film electrode having a porous tin oxide particle layer and a film electrode having a zinc oxide particle layer were prepared using the tin oxide-containing paste and the zinc oxide-containing paste prepared in the above-mentioned Example.

### (2) Preparation of Dye-Sensitized Solar Battery

Tetrabutylammonium salt of bisisocyanate bisbipyridyl ruthenium complex (N719) was used a Ru bipyridyl complex dye. The Ru bipyridyl complex dye was dissolved in a mixed solvent of acetonitrile:tert-butanol (1:1) to prepare a dye solution (concentration: 3×10⁻⁴ mole per liter). The porous semiconductor film electrode substrate was immersed in the dye solution, and left at 40° C. for 60 minutes while stirring to complete adsorption of the dye. Thus, a dye-sensitized titanium oxide ITO-PET film electrode was prepared.

A polyethylene terephthalate (PET) film was coated with ITO to a conductive membrane. The obtained film had the thickness of 400 μm and the surface resistance of 15Ω per square. The ITO surface of the film was coated with a platinum membrane (thickness: 100 nm) according to a sputtering method. The obtained conductive film (sheet resistance: 0.8Ω per square) was used as a counter electrode.

The semiconductor layer of the dye-sensitized ITO-PET film electrode was scraped out from the film to form a light-receiving layer having a light receiving area of 40 cm² (5 cm×8 cm). The platinum evaporated ITO-PET film was placed on the electrode, and a non-aqueous organic electrolytic solution was injected into the space between them by a capillary action. The solution comprised propylene carbonate, tert-butylpyridine, lithium iodide and iodine. A thermally setting sealing material of an epoxy type was injected into the edges of the prepared sandwiched film battery, and heated at 110° C. for 20 minutes to harden the sealing material. The prepared solar battery of a film type had a card size, the thickness of about 600 μm and the weight of 3.6 g.

### (3) Evaluation of Photovoltaic Conversion Efficiency of Solar Battery of Film Type

The solar battery of the film type was irradiated from the side of the dye-sensitized semiconductor film electrode with pseudo sun light (AM1.5) with the incident light strength of 100 mW/cm² by using a solar simulator having a xenon lump of 500 W. The battery was fixed on a stage of a thermostat. The temperature of the element was adjusted to 40° C. while irradiating it with light. The DC voltage applied to the element was scanned with an ampere-volt source meter at a constant rate of 10 mV per second, and the photocurrent output from the element was measured to determine the photocurrent-voltage characteristic. The obtained short-circuit photocurrent density (Jsc) and energy conversion efficiency (n) as well as the composition of the paste coated on the film electrode with respect to the above-mentioned various elements are set forth in Table 3.

TABLE 1

| | Semiconductor | | Water | Semiconductor | |
|---|---|---|---|---|---|
| Paste | nanoparticles | | content | content | |
| number | | (Brookite) | (wt %) | (wt %) | Alcohol |
| 1 | TiO₂ | Present | 0 | 16 | t-butanol |
| 2 | TiO₂ | Present | 5 | 16 | t-butanol |
| 3 | TiO₂ | Present | 10 | 16 | t-butanol |
| 4 | TiO₂ | Present | 15 | 16 | t-butanol |
| 5 | TiO₂ | Present | 27 | 16 | t-butanol |
| 6 | TiO₂ | Present | 35 | 16 | t-butanol |
| 7 | TiO₂ | Present | 45 | 16 | t-butanol |
| 8 | TiO₂ | Present | 60 | 16 | t-butanol |
| 9 | TiO₂ | Present | 27 | 16 | 2-propanol |
| 10 | TiO₂ | Present | 27 | 16 | 1-pentanol |
| 11 | TiO₂ | Present | 27 | 16 | 1-hexanol |
| 12 | TiO₂ | Present | 27 | 5 | t-butanol |
| 13 | TiO₂ | Present | 27 | 10 | t-butanol |
| 14 | TiO₂ | Present | 27 | 20 | t-butanol |
| 15 | TiO₂ | Present | 27 | 35 | t-butanol |
| 16 | TiO₂ | Present | 27 | 50 | t-butanol |
| 17 | TiO₂ | None | 27 | 16 | t-butanol |
| 18 | SnO₂ | Present | 30 | 15 | t-butanol |
| 19 | ZnO | Present | 25 | 20 | t-butanol |
| 20 | CdS | Present | 23 | 22 | t-butanol |

TABLE 2

| | | | Coating capability of | | |
|---|---|---|---|---|---|
| | | | paste | | |
| | Semi- | Vis- | Uniformity | Resistance | |
| Paste | conductor | cosity | of | to peeling | Storage |
| number | nanoparticles | (mP · s) | membrane | out | stability |
| 1 | TiO₂ | 100 | Fluid (no membrane | | Precipitation |
| | | | formed) | | |
| 2 | TiO₂ | 250 | Fluid (no membrane | | Precipitation |
| | | | formed) | | |
| 3 | TiO₂ | 800 | C | C | B |
| 4 | TiO₂ | 1,500 | B | B | A |
| 5 | TiO₂ | 2,400 | A | A | A |
| 6 | TiO₂ | 1,000 | A | A | B |
| 7 | TiO₂ | 800 | C | C | C |
| 8 | TiO₂ | 300 | Not coated because of | | Precipitation |
| | | | repellency | | |
| 9 | TiO₂ | 2,000 | B | A | B |
| 10 | TiO₂ | 1,000 | C | B | C |
| 11 | TiO₂ | 400 | Insufficient membrane | | Two phases |
| | | | formation | | seperation |
| 12 | TiO₂ | 1,100 | B | B | A |
| 13 | TiO₂ | 2,000 | A | A | A |
| 14 | TiO₂ | 3,500 | A | A | A |
| 15 | TiO₂ | 4,000 | B | B | B |
| 16 | TiO₂ | 12,000 | C | C | Aggregation |
| 17 | TiO₂ | 1,100 | C | C | B |
| 18 | SnO₂ | 1,800 | A | B | A |
| 19 | ZnO | 2,000 | B | B | B |
| 20 | CdS | 1,000 | B | C | C |

TABLE 3

| | | | | Photovoltaic conversion | |
|---|---|---|---|---|---|
| | | | | efficiency | |
| | | | | | Energy |
| | | | | | Con- |
| | Composition of paste | | | | version |
| Elec- | | Semi- | | Short-Circuit | effi- |
| trode | Paste | conductor | Binder | Photocurrent | ciency |
| number | number | nanoparticles | content | density (Jsc) | (η) |
| 1 | 4 | TiO₂ | 0 wt % | 11.0 mA/cm² | 3.5% |
| 2 | 18 | SnO₂ | 0 wt % | 8.0 mA/cm² | 2.1% |
| 3 | 19 | ZnO | 0 wt % | 7.2 mA/cm² | 2.0% |

As is evident from the results shown in Table 1, the paste has the following practical values for formation of a porous semiconductor layer.

1) In the paste compositions containing no binder, the compositions having the water content of less than 8 wt % are fluid at the coating step because of the low viscosity. Accordingly, the coated compositions cannot be fixed to the substrate. Further, precipitation was observed in the stored compositions. Therefore, these compositions cannot be used as pastes for coating. The composition having the water content of more than 47 wt % is also fluid in the coating step because of the low viscosity. In addition of the defect of the low viscosity, the coated composition is repelled by the substrate. Therefore, the composition also cannot be used as pastes for coating. With respect to the compositions having the water content in the range of 8 wt % to 47 wt %, the pastes having the water content in the range of 15 to 35 wt % show the most excellent coating capability.

2) With respect to the alcohol contained in the composition, butanol (number of carbon atoms: 4) and propanol (number of carbon atoms: 3) give pastes having excellent viscosity and coating capability. Pentanol (number of carbon atoms: 5) gives a paste having a slightly degraded quality. Hexanol (number of carbon atoms: 6) causes a phase separation with water. Therefore, hexanol cannot give a usable paste.

3) With respect to the content of the semiconductor nanoparticles in the composition, the paste having the content of less than 8 wt % has such a low viscosity that the uniformity of the coated membrane is degraded. The paste having the content of higher than 40 wt % has a high viscosity. Further, aggregation of particles is observed. Therefore, the uniformity and quality of the coated membrane is also degraded.

4) The water content is adjusted in the paste containing brookite crystals in the semiconductor nanoparticles of the composition to give an excellent paste. On the other hand, the paste containing no brookite crystals gives a coated membrane somewhat degraded in the uniformity and adhesion to the substrate.

5) In the case that a metal oxide semiconductor, such as tin oxide, zinc oxide or a sulfide semiconductor, such as cadmium sulfide is used in place of titanium dioxide, viscous pastes can be obtained by adjusting the water content within the appropriate range.

As is also evident from the results shown in Table 3, the paste of the invention can be used to give an excellent practical ability of photovoltaic conversion efficiency to a photovoltaic electrode of a solar battery.

As is described above, the liquid paste containing semiconductor nanoparticles satisfying the conditions of the composition defined in the present invention shows a high viscosity and excellent storage stability, even though the composition does not contain a binder. The porous membrane formed by coating a film with the paste has good membrane quality and a high resistance to peeling off. The semiconductor membrane formed by coating a film with the paste of the invention, and drying them at a low temperature of not higher than 150° C. shows a high conductivity. Therefore, the paste of the invention is effectively used in preparation of a film electrode. A dye-sensitized solar battery can be provided by using the film electrode.

### INDUSTRIAL AVAILABILITY

The paste of the invention can be used as a coating paste according to a doctor blade method or method or a screen printing method to give a porous semiconductor membrane excellent in quality and adhesion. The paste of the invention can be used with a film substrate to form a nano-porous membrane at a low temperature to give a film-type or plastic-type dye-sensitized solar battery excellent in photovoltaic conversion efficiency.

1. A viscous dispersion comprising crystalline semiconductor nanoparticles dispersed in a dispersion medium, wherein the dispersion medium is a mixture comprising 53 to 92 wt % of a hydrophilic organic medium and 8 to 47 wt % of water, said hydrophilic organic medium comprising an alcohol having 3 to 5 carbon atoms as a main component, wherein the dispersion medium essentially does not contain an organic binder, an amount of said organic binder being less than 2 wt % of the medium, and wherein the dispersion comprises 8 to 40 wt % of the dispersed crystalline semiconductor nanoparticles based on the total amount of the dispersion.

2. The viscous dispersion as claimed in claim 1, wherein the dispersion is made for formation of a porous semiconductor layer.

3. The viscous dispersion as claimed in claim 1, wherein the hydrophilic organic medium comprises more than 70 vol % of the alcohol having 3 to 5 carbon atoms.

4. The viscous dispersion as claimed in claim 1, wherein the alcohol having 3 to 5 carbon atoms is tert-butanol.

5. The viscous dispersion as claimed in claim 1, wherein the crystalline semiconductor nanoparticles are nanoparticles of titanium dioxide.

6. The viscous dispersion as claimed in claim 5, wherein the nanoparticles of titanium dioxide is a mixture comprising anatase crystals and brookite crystals.

7. The viscous dispersion as claimed in claim 1, wherein the dispersion has a viscosity of not less than 800 mPa·s.

8. The viscous dispersion as claimed in claim 7, wherein the dispersions has a viscosity of 3,000 to 15,000 mPa·s.

9. The viscous dispersion as claimed in claim 1, wherein the dispersion medium is a mixture comprising 65 to 85 wt % of a hydrophilic organic medium and 15 to 35 wt % of water, said hydrophilic organic medium comprising an alcohol having 3 to 5 carbon atoms as a main component.

10. The viscous dispersion as claimed in claim 1, wherein the dispersion comprises 15 to 38 wt % of the dispersed crystalline semiconductor nanoparticles based on the total amount of the dispersion.

11. The viscous dispersion as claimed in claim 1, wherein the amount of the organic binder is less than 1 wt % of the dispersion medium.

12. The viscous dispersion as claimed in claim 1, wherein the amount of the organic binder is less than 2 wt % based on the amount of the crystalline semiconductor nanoparticles.
